(19) United States
(12) Patent Application Publication
(10) Pub. No.: US 2015/0223482 A1
(43) Pub. Date: Aug. 13, 2015

(54) COMBINED CONFECTIONERY

(71) Applicant: The Nisshin Oillio Group, Ltd., Chuo-ku, Tokyo (JP)

(72) Inventors: Tomomi Suganuma, Yokosuka-shi (JP); Munyee Chong, Yokosuka-shi (JP); Hidetaka Uehara, Yokosuka-shi (JP); Yoshiyuki Hatano, Yokosuka-shi (JP); Atsushi Ohara, Yokosuka-shi (JP)

(73) Assignee: The Nisshin Oillio Group, Ltd., Chuo-ku, Tokyo (JP)

(21) Appl. No.: 14/422,805

(22) PCT Filed: Aug. 26, 2013
(86) PCT No.: PCT/JP2013/072716

§ 371 Date: Feb. 20, 2015

(30) Foreign Application Priority Data
Aug. 29, 2012 (JP) 2012-189078

(51) Int. Cl. A23D 9/00; A21D 2/16; A23G 1/36

(52) U.S. Cl. CPC A23D 9/00; A23G 1/36; A21D 2/165; A23V 2002/00

(57) ABSTRACT

The purpose of the present invention is to provide a combined confectionery that comprises a combination of a chocolate with a baked confectionery, wherein whitening on a baked confectionery part and blooming on a chocolate part, said whitening and blooming occurring with the lapse of time, are prevented. A combined confectionery that comprises a combination of a baked confectionery using oil-and-fat which satisfy the following requirements (a), (b) and (c) with a chocolate, the oil-and-fat components of which satisfy the following requirements (A) and (B): (a) the CN40-46 content being 2-30 mass %; (b) the sum of the S2U and SU2 contents (S2U+SU2) being 45-85 mass %; (c) the ratio by mass of SU2 to S2U+SU2 [SU2/(S2U+SU2)] being 0.50 or greater; (A) the SOS content being 40-90 mass %; and (B) the sum of the SU2 and U3 contents (SU2+U3) being 10-40 mass %.

### TECHNICAL FIELD

This invention relates to a combined confectionery that includes a combination of a baked confectionery with a chocolate, wherein whitening on a baked confectionery part and blooming on a chocolate part, the whitening and blooming occurring with the lapse of time, are prevented.

### BACKGROUND ART

A baked confectionery such as biscuits, cookies is utilized for not only the baked confectionery itself, but also a combined confectionery configured such that the baked confectionery is combined with a chocolate. The combined confectionery can be produced by, for example, combining a baked confectionery preliminarily baked and a chocolate preliminarily prepared, or spreading the preliminarily prepared chocolate on the baked confectionery dough or filling in the baked confectionery dough with the preliminarily prepared chocolate so as to bake.

It is known that with regard to a combined confectionery comprised of a combination of a baked confectionery and a chocolate, oil-and-fats included in the baked confectionery and the chocolate migrates into each other during distribution and storage (the oil-and-fat included in the baked confectionery migrates into the chocolate and the oil-and-fat included in the chocolate migrates into the baked confectionery). If the migration of the oil-and-fat included in the baked confectionery and the chocolate of the combined confectionery occurs, “whitening” may be caused in which white powder spot appears on a surface of a baked confectionery part of the combined confectionery, and blooming may be caused on chocolate part of the combined confectionery. As mentioned above, if the baked confectionery part of the combined confectionery causes the whitening and the chocolate part causes the blooming, the commodity value of combined confectionery would be lost.

As the suppressing means of the whitening on the baked confectionery part and the blooming on the chocolate part of the combined confectionery in association with the migration of the oil-and-fat included in the baked confectionery and the chocolate of the combined confectionery, it has been proposed to use an oil-and-fat having a specific SFC for a kneading oil-and-fat blended in the baked confectionery (Patent Literature 1), and to use a specific triglyceride (Patent Literature 2). In addition, it has been proposed to use a chocolate including a special type triacylglycerol that has a saturated fatty acid having a carbon number of 20 to 24 as the constituent fatty acid (Patent Literature 3).

However, any of the kneading oil-and-fats blended in the baked confectionery described in Patent Literature 1 and Patent Literature 2 is an oil-and-fat using a partially hydrogenated oil-and-fat including a trans fatty acid in a large amount, thus it is not corresponding to the needs in the times from the view point of the trans fatty acid problem in recent years. In addition, the triacylglycerol described in Patent Literature 3 is expensive, and additionally has a high melting point, thus it has a weak point that meltability in the mouth of chocolate is damaged. In addition, the above-mentioned trials that improve either the baked confectionery or the chocolate have been unsatisfactory in effectiveness.

Then, a technique or method for providing a combined confectionery has been desired, the combined confectionery being more effective and corresponding to the needs in the times, and being capable of preventing whitening on a baked confectionery part and blooming on a chocolate part.

### PRIOR ART DOCUMENTS

### Patent Literature

Patent Literature 1: JP-2004-16096 A1

Patent Literature 2: JP-1997 (Heisei-9)-37705 A1

Patent Literature 3: JP-1995 (Heisei-7)-264983 A1

### SUMMARY OF THE INVENTION

### Problems to be Solved by the Invention

It is an object of the invention to provide a combined confectionery that includes a combination of a baked confectionery with a chocolate, wherein whitening on a baked confectionery part and blooming on a chocolate part, the whitening and blooming occurring with the lapse of time, are prevented.

### Means for Solving the Problems

The inventors have been earnestly studied so as to solve the above-mentioned problem, as a result, the inventors have found that a baked confectionery using an oil-and-fat satisfying a specific triacylglycerol composition is combined with a chocolate of which oil-and-fat components satisfying a specific triacylglycerol composition, thereby whitening on a baked confectionery part and blooming on a chocolate part, the whitening and blooming occurring with the lapse of time, are prevented, and the present invention has been completed.

Namely, one of embodiments of the invention is a combined confectionery that comprises a combination of a baked confectionery using an oil-and-fat which satisfies the following requirements (a), (b) and (c) with a chocolate of which oil-and-fat components satisfy the following requirements (A) and (B):

(a) a CN 40 to 46 content being 2 to 30 mass %;
(b) the sum of S2U and SU2 contents (S2U+SU2) being 45 to 85 mass %;
(c) the ratio of mass of SU2 to (S2U+SU2) [SU2/(S2U+SU2)] being not less than 0.50;
(A) a SOS content being 40 to 90 mass %; and
(B) the sum of the SU2 and U3 contents (SU2+U3) being 10 to 40 mass %.

Provided that the CN 40 to 46, S, U, O, S2U, SU2, SOS and U3 represent the following compounds respectively.

CN 40 to 46: a triacylglycerol configured such that the total carbon number of the fatty acid residue constituting the triacylglycerol being 40 to 46;
S: a saturated fatty acid having a carbon number of not less than 16;
U: an unsaturated fatty acid having a carbon number of not less than 16;
O: oleic acid;
S2U: a triacylglycerol configured such that two molecules of S and one molecule of U are bonded;
SU2: a triacylglycerol configured such that one molecule of S and two molecules of U are bonded;
SOS: a triacylglycerol configured such that S is bonded to the first and third positions and O is bonded to the second position; and
U3: a triacylglycerol configured such that three molecules of U are bonded.

In addition, a preferable embodiment of the invention is the combined confectionery according to the above, wherein the oil-and-fat used for the baked confectionery satisfies the following requirements (d) and (e).

(d): a S3 content being not more than 15 mass %; and
(e): a U3 content being not more than 18 mass %.

Provided that the S3 represents the following compound.

S3: a triacylglycerol configured such that three molecules of S are bonded.

In addition, a preferable embodiment of the invention is the combined confectionery according to the above, wherein the oil-and-fat used for the baked confectionery satisfies the following requirement (f). (f): the ratio of mass (USU/SU2) of USU to SU2 being not less than 0.02.

Provided that the USU represents the following compound.

USU: a triacylglycerol configured such that U is bonded to the first and third positions and S is bonded to the second position.

In addition, a preferable embodiment of the invention is the combined confectionery according to the above, wherein the oil-and-fat used for the baked confectionery comprises 4 to 60 mass % of a transesterified oil-and-fat of a lauric-type oil-and-fat and a non-lauric-type oil-and-fat and 40 to 96 mass % of a low melting point fraction obtained by fractionating a non-lauric-type oil-and-fat.

In addition, a preferable embodiment of the invention is the combined confectionery according to the above, wherein the transesterified oil-and-fat of a lauric-type oil-and-fat and a non-lauric-type oil-and-fat is not less than one transesterified oil-and-fat selected from the group consisting of the following Oil-and-fat A and Oil-and-fat B.

Oil-and-fat A: an oil-and-fat obtained by being transesterified comprising not more than 15 mass % of an unsaturated fatty acid, 20 to 60 mass % of a saturated fatty acid having a carbon number of 12 to 14, 40 to 80 mass % of a saturated fatty acid having a carbon number of 16 to 18 in the whole constituent fatty acid.
Oil-and-fat B: an oil-and-fat obtained by being transesterified comprising 25 to 45 mass % of an unsaturated fatty acid, 15 to 35 mass % of a saturated fatty acid having a carbon number of 12 to 14, 25 to 45 mass % of a saturated fatty acid having a carbon number of 16 to 18 in the whole constituent fatty acid.

In addition, a preferable embodiment of the invention is the combined confectionery according to the above, wherein the low melting point fraction obtained by fractionating a non-lauric-type oil-and-fat has an iodine value of not less than 62, and is an oil-and-fat comprising not less than one low melting point fraction selected from the group consisting of a low melting point fraction obtained by fractionating not less than one oil-and-fat selected from the group consisting of a palm-based oil-and-fat and a transesterified oil-and-fat including a palm-based oil-and-fat as a raw material, and a low melting point part comprising not less than 50 mass % of StU2.

Provided that the St and StU2 represent the following compounds.

St: stearic acid;
StU2: a triacylglycerol configured such that one molecule of St and two molecules of U are bonded.

In addition, a preferable embodiment of the invention is the combined confectionery according to the above, wherein the oil-and-fat components of the chocolate satisfy the following requirement (C).

(C): the ratio of mass (SU2/U3) of SU2 to U3 included in the oil-and-fat being not less than 1.

In addition, a preferable embodiment of the invention is the combined confectionery according to the above, wherein the oil-and-fat components of the chocolate satisfy the following requirement (D).

(D): a StOSt content being 27 to 65 mass %.

Provided that the StOSt represents the following compound.

StOSt: a triacylglycerol configured such that St is bonded to the first and third positions and O is bonded to the second position.

In addition, a preferable embodiment of the invention is the combined confectionery according to the above, wherein the oil-and-fat components of the chocolate comprises 60 to 95 mass % of an oil-and-fat rich in SOS, and 5 to 40 mass % of the low melting point fraction obtained by fractionating a non-lauric-type oil-and-fat.

In addition, a preferable embodiment of the invention is the combined confectionery according to the above, wherein the oil-and-fat rich in SOS comprises 20 to 100 mass % of a StOSt oil-and-fat.

### Advantages of the Invention

According to the invention, a combined confectionery can be provided that includes a combination of a baked confectionery with a chocolate, wherein whitening on a baked confectionery part and blooming on a chocolate part, the whitening and blooming occurring with the lapse of time, are prevented.

### EMBODIMENT FOR CARRYING OUT THE INVENTION

Hereinafter, the invention will be explained in detail.

### I. Baked Confectionery

The baked confectionery constituting the combined confectionery of the invention is a baked confectionery that satisfies the following requirements (a), (b) and (c):

(a) a CN 40 to 46 content being 2 to 30 mass %;
(b) the sum of S2U and SU2 contents (S2U+SU2) being 45 to 85 mass %;
(c) the ratio of mass of SU2 to (S2U+SU2) [SU2/(S2U+SU2)] being not less than 0.50.

In the oil-and-fat used for the baked confectionery constituting the combined confectionery of the invention, the CN 40 to 46 content (requirement (a)) is 2 to 30 mass %, preferably 3 to 25 mass % and more preferably 4 to 20 mass %. If the CN 40 to 46 content falls within the above-mentioned range, whitening on a baked confectionery part and blooming on a chocolate part, the whitening and blooming occurring on a combined confectionery with the lapse of time, can be prevented.

Further, in the invention, the CN 40 to 46 represents a triacylglycerol configured such that the total carbon number of the fatty acid residue constituting the triacylglycerol is 40 to 46. As the triacylglycerol configured such that the total carbon number of the fatty acid residue is 40, for example, a triacylglycerol configured such that the fatty acid residue is constituted of lauric acid (carbon number 12), lauric acid (carbon number 12), and palmitic acid (carbon number 16) is included. As the triacylglycerol configured such that the total carbon number of the fatty acid residue is 42, for example, a triacylglycerol configured such that the fatty acid residue is constituted of lauric acid (carbon number 12), myristic acid (carbon number 14), and palmitic acid (carbon number 16) is included. As the triacylglycerol configured such that the total carbon number of the fatty acid residue is 44, for example, a triacylglycerol configured such that the fatty acid residue is constituted of lauric acid (carbon number 12), palmitic acid (carbon number 16), and palmitic acid (carbon number 16) is included. In addition, as the triacylglycerol configured such that the total carbon number of the fatty acid residue is 46, for example, a triacylglycerol configured such that the fatty acid residue is constituted of lauric acid (carbon number 12), palmitic acid (carbon number 16), and stearic acid (carbon number 18) is included.

Hereinafter, a triacylglycerol can be referred to as “TAG”.

In the oil-and-fat used for the baked confectionery constituting the combined confectionery of the invention, the sum of S2U and SU2 contents (S2U+SU2) (requirement (b)) is 45 to 85 mass %, preferably 50 to 85 mass % and more preferably 50 to 80 mass %. If the sum of S2U and SU2 contents (S2U+SU2) falls within the above-mentioned range, whitening on a baked confectionery part and blooming on a chocolate part, the whitening and blooming occurring on a combined confectionery with the lapse of time, can be prevented.

Further, in the invention, S represents a saturated fatty acid having a carbon number of not less than 16, U represents an unsaturated fatty acid having a carbon number of not less than 16. Consequently, in the invention, S2U represents a triacylglycerol configured such that two fatty acid residues constituting the triacylglycerol are saturated fatty acid residues having a carbon number of not less than 16, and one fatty acid residue constituting the triacylglycerol is unsaturated fatty acid residue having a carbon number of not less than 16. In addition, in the invention, SU2 represents a triacylglycerol configured such that one fatty acid residue constituting the triacylglycerol is saturated fatty acid residue having a carbon number of not less than 16, and two fatty acid residues constituting the triacylglycerol are unsaturated fatty acid residues having a carbon number of not less than 16.

In the invention, it is preferable that S is a saturated fatty acid having a carbon number of 16 to 18, and U is an unsaturated fatty acid having a carbon number of 18.

In the oil-and-fat used for the baked confectionery constituting the combined confectionery of the invention, the ratio of mass of SU2 to (S2U+SU2) [SU2/(S2U+SU2)] (requirement (c)) is not less than 0.50, preferably not less than 0.55, and more preferably not less than 0.60. The upper limit is not particularly specified, but it is difficult to make it 1.0 in terms of actual producing, and 0.9 is appropriate. If the ratio of mass of SU2 to (S2U+SU2) [SU2/(S2U+SU2)] falls within the above-mentioned range, whitening on a baked confectionery part and blooming on a chocolate part, the whitening and blooming occurring on a combined confectionery with the lapse of time, can be prevented.

According to the preferable embodiment of the invention, in the oil-and-fat used for the baked confectionery constituting the combined confectionery of the invention, a S3 content (requirement (d)) is preferably not more than 15 mass %, more preferably not more than 13 mass %, further more preferably 0 to 11 mass %. In addition, in the oil-and-fat used for the baked confectionery constituting the combined confectionery of the invention, a U3 content (requirement (e)) is preferably not more than 18 mass %, more preferably not more than 16 mass %, further more preferably 0 to 14 mass %. If the S3 content and the U3 content fall within the above-mentioned ranges, whitening on a baked confectionery part and blooming on a chocolate part, the whitening and blooming occurring on a combined confectionery with the lapse of time, can be prevented.

Further, in the invention, the S3 represents a triacylglycerol configured such that three fatty acid residues constituting the triacylglycerol are saturated fatty acid residues having a carbon number of not less than 16. In addition, in the invention, the U3 represents a triacylglycerol configured such that three fatty acid residues constituting the triacylglycerol are unsaturated fatty acid residues having a carbon number of not less than 16.

According to the preferable embodiment of the invention, in the oil-and-fat used for the baked confectionery constituting the combined confectionery of the invention, the ratio of mass (USU/SU2) of USU to SU2 (requirement (f)) is preferably not less than 0.02, more preferably not less than 0.06, and further more preferably not less than 0.1. The upper limit is not particularly specified, but it is difficult to make it 1.0 in terms of actual producing, and 0.9 is appropriate and 0.6 is more appropriate. If the ratio of mass (USU/SU2) of USU to SU2 falls within the above-mentioned range, whitening on a baked confectionery part and blooming on a chocolate part, the whitening and blooming occurring on a combined confectionery with the lapse of time, can be prevented. Further, the USU represents a triacylglycerol configured such that an unsaturated fatty acid residue having a carbon number of not less than 16 is bonded to the first and third positions and a saturated fatty acid residue having a carbon number of not less than 16 is bonded to the second position.

According to the preferable embodiment of the invention, it is preferable that the oil-and-fat used for the baked confectionery constituting the combined confectionery of the invention includes a StU2 as the SU2. The StU2 content of the oil-and-fat is preferably not less than 10 mass %, more preferably not less than 20 mass %, and further more preferably 30 to 60 mass %. If the StU2 content of the oil-and-fat falls within the above-mentioned range, whitening in a baked confectionery part, the whitening occurring in a combined confectionery with the lapse of time, can be prevented.

Further, in the invention, the St represents stearic acid and the U represents an unsaturated fatty acid having a carbon number of not less than 16. Consequently, in the invention, the StU2 represents a triacylglycerol configured such that one fatty acid residues constituting the triacylglycerol is a stearic acid residue, and two fatty acid residues constituting the triacylglycerol are unsaturated fatty acid residues having a carbon number of not less than 16.

According to the preferable embodiment of the invention, it is preferable that the oil-and-fat used for the baked confectionery constituting the combined confectionery of the invention substantially include no trans fatty acid. The trans fatty acid content is preferably not more than 5 mass %, more preferably not more than 2 mass %, and further more preferably not more than 1 mass %. The oil-and-fat used for the baked confectionery constituting the combined confectionery of the invention can be produced without using a partially hydrogenated oil-and-fat including the trans fatty acid in a large amount, thus the oil-and-fat can be configured to substantially include no trans fatty acid.

The oil-and-fat used for the baked confectionery constituting the combined confectionery of the invention is not particularly limited, if it satisfies the above-mentioned requirements (a), (b) and (c), a usual edible oil-and-fat (soybean oil, rapeseed oil, corn oil, sunflower oil, safflower oil, sesame oil, cotton seed oil, rice oil, olive oil, peanut oil, flaxseed oil, palm oil, palm kernel oil, coconut oil, cacao butter, milk fat, a mixture oil-and-fat of these oil-and-fats, a processed oil-and-fat of these oil-and-fats or the mixture oil-and-fats (a transesterified oil-and-fat, a fractionated oil-and-fat, a hydrogenated oil-and-fat and the like) can be used. As a preferable example of the oil-and-fat used for the baked confectionery constituting the combined confectionery of the invention, a mixture oil-and-fat including a transesterified oil-and-fat of a lauric-type oil-and-fat and a non-lauric-type oil-and-fat, and a low melting point fraction obtained by fractionating a non-lauric-type oil-and-fat can be included. The above-mentioned transesterified oil-and-fat of a lauric-type oil-and-fat and a non-lauric-type oil-and-fat is included in the oil-and-fat preferably in an amount of 4 to 60 mass %, more preferably in an amount of 6 to 50 mass %, further more preferably in an amount of 8 to 40 mass %. In addition, the above-mentioned low melting point fraction obtained by fractionating a non-lauric-type oil-and-fat is included in the oil-and-fat preferably in an amount of 40 to 96 mass %, more preferably in an amount of 50 to 94 mass %, further more preferably in an amount of 60 to 92 mass %.

According to the preferable embodiment of the invention, as the above-mentioned transesterified oil-and-fat of a lauric-type oil-and-fat and a non-lauric-type oil-and-fat, in more particular, Oil-and-fat A and Oil-and-fat B explained next can be included. Further, in the invention, the lauric-type oil-and-fat means an oil-and-fat that includes not less than 30 mass % (preferably not less than 40 mass %) of a lauric acid in the whole constituent fatty acid. As specific examples of the lauric-type oil-and-fat, perm kernel oil, coconut oil, a mixture oil-and-fat of these oil-and-fats, a processed oil-and-fat of these oil-and-fats or the mixture oil-and-fats (a transesterified oil-and-fat, a fractionated oil-and-fat, a hydrogenated oil-and-fat and the like) can be included. In addition, in the invention, the non-lauric-type oil-and-fat means an oil-and-fat that includes not less than 90 mass % of a fatty acid having a carbon number of not less than 16 in the whole constituent fatty acid. As specific examples of the non-lauric-type oil-and-fat, soybean oil, rapeseed oil, cotton seed oil, sunflower oil, safflower oil, corn oil, palm oil, a mixture oil-and-fat of these oil-and-fats, a processed oil-and-fat of these oil-and-fats or the mixture oil-and-fats (a transesterified oil-and-fat, a fractionated oil-and-fat, a hydrogenated oil-and-fat and the like) can be included.

It is preferable that the above-mentioned transesterified oil-and-fat of the lauric-type oil-and-fat and the non-lauric-type oil-and-fat includes the Oil-and-fat A as one embodiment thereof. In the invention, the Oil-and-fat A means an oil-and-fat that includes not more than 15 mass % of an unsaturated fatty acid, 20 to 60 mass % of a saturated fatty acid having a carbon number of 12 to 14, 40 to 80 mass % of a saturated fatty acid having a carbon number of 16 to 18 in the whole constituent fatty acid, and obtained by being transesterified.

In the Oil-and-fat A used for the invention, the content of the unsaturated fatty acid in the whole constituent fatty acid is not more than 15 mass %, preferably not more than 10 mass %, more preferably not more than 5 mass %, and further more preferably 0 to 2 mass %.

In addition, in the Oil-and-fat A used for the invention, the content of the saturated fatty acid having a carbon number of 12 to 14 in the whole constituent fatty acid is 20 to 60 mass %, preferably 25 to 40 mass %, more preferably 28 to 35 mass %, and further more preferably 28 to 33 mass %.

In addition, in the Oil-and-fat A used for the invention, the content of the saturated fatty acid having a carbon number of 16 to 18 in the whole constituent fatty acid is 40 to 80 mass %, preferably 46 to 70 mass %, more preferably 52 to 68 mass %, and further more preferably 61 to 68 mass %.

As a preferable example of the Oil-and-fat A used for the invention, an oil-and-fat can be exemplified, the oil-and-fat being obtained by transesterifying a mixture oil-and-fat of a lauric-type oil-and-fat and a palm-based oil-and-fat that is a non-lauric-type oil-and-fat, after that, hydrogenating the transesterified oil-and-fat until the iodide value becomes not more than 10 (preferably not more than 2). In addition, an oil-and-fat can be exemplified, the oil-and-fat being obtained by hydrogenating each of lauric-type oil-and-fat and palm-based oil-and-fat separately so as to have an iodine value of not more than 10 (preferably not more than 2), after that, transesterifying the mixture oil-and-fat. In addition, an oil-and-fat can be exemplified, the oil-and-fat being obtained by transesterifying a mixture oil-and-fat of a lauric-type oil-and-fat having an iodine value of not more than 10 and a palm-based oil-and-fat having an iodine value of not more than 20. In the invention, the palm-based oil-and-fat means a palm oil itself and a processed oil-and-fat (a transesterified oil-and-fat, a fractionated oil-and-fat, a hydrogenated oil-and-fat and the like) of the palm oil. As specific examples of the palm-based oil-and-fat, palm oil, palm olein, palm mid fraction, palm stearin and the like can be included.

It is preferable that the combination of the lauric-type oil-and-fat and the palm-based oil-and-fat that are raw material oil-and-fats of the Oil-and-fat A used for the invention is a combination of perm kernel and palm oil, palm kernel olein and palm stearin, and perm kernel stearin and hard stearin.

In the Oil-and-fat A used for the invention, the mixture ratio (mass ratio) of the lauric-type oil-and-fat and the palm-based oil-and-fat (lauric-type oil-and-fat:palm-based oil-and-fat) is preferably 30:70 to 70:30, and more preferably 40:60 to 60:40.

A transesterification reaction for preparing the Oil-and-fat A used for the invention is not particularly limited, and either a nonselective transesterification (a random transesterification) that has a low positional selectivity or a selective transesterification (a positional specificity transesterification) that has a high positional selectivity may be used, but it is preferred to use the nonselective transesterification. In addition, a transesterification method for preparing the Oil-and-fat A used for the invention is not particularly limited, and either a chemical transesterification or an enzymatic transesterification may be used, but it is preferred to use the chemical transesterification. The chemical transesterification is carried out by using a chemical catalyst such as sodiummethylate and the like as a catalyst, and the reaction becomes a nonselective transesterification that has a low positional selectivity.

The chemical transesterification reaction can be carried out, for example, in accordance with a conventional method, by sufficiently drying raw material oil-and-fats, adding 0.1 to 1 mass % of catalysts to the raw material oil-and-fats, and then stirring under reduced pressure, at 80 to 120 degrees C., for 0.5 to 1 hour, so as to be reacted. After completion of the transesterification reaction, decolorization treatment and deodorization treatment that are performed in a usual refinement process of edible oil can be carried out after the catalyst is washed off with water.

In addition, a method of the hydrogenation for preparing the Oil-and-fat A used in the invention is not particularly limited, but the hydrogenation can be carried out by a usual method. The hydrogenation can be carried out, for example, under the condition that the hydrogen pressure is 0.02 to 0.3 MPa and the temperature is 160 to 200 degrees C. in the presence of nickel catalyst.

It is preferable that the above-mentioned transesterified oil-and-fat of the lauric-type oil-and-fat and the non-lauric-type oil-and-fat includes the Oil-and-fat B as one embodiment thereof. In the invention, the Oil-and-fat B means an oil-and-fat that includes 25 to 45 mass % of an unsaturated fatty acid, 15 to 35 mass % of a saturated fatty acid having a carbon number of 12 to 14, 25 to 45 mass % of a saturated fatty acid having a carbon number of 16 to 18 in the whole constituent fatty acid, and obtained by being transesterified.

In the Oil-and-fat B used for the invention, the content of the unsaturated fatty acid in the whole constituent fatty acid is 25 to 45 mass %, preferably 28 to 42 mass %, more preferably 30 to 40 mass %, and further more preferably 32 to 38 mass %.

In addition, in the Oil-and-fat B used for the invention, the content of the saturated fatty acid having a carbon number of 12 to 14 in the whole constituent fatty acid is 15 to 35 mass %, preferably 18 to 32 mass %, more preferably 20 to 30 mass %, and further more preferably 22 to 28 mass %.

In addition, in the Oil-and-fat B used for the invention, the content of the saturated fatty acid having a carbon number of 16 to 18 in the whole constituent fatty acid is 25 to 45 mass %, preferably 28 to 42 mass %, more preferably 30 to 40 mass %, and further more preferably 32 to 38 mass %.

As a preferable example of the Oil-and-fat B used for the invention, a transesterified oil-and-fat of a lauric-type oil-and-fat and a palm-based oil-and-fat can be exemplified. It is preferable that the combination of the lauric-type oil-and-fat and the palm-based oil-and-fat that are raw material oil-and-fats of the Oil-and-fat B used for the invention is a combination of perm kernel and palm oil, palm kernel olein and palm oil, and perm kernel olein and palm stearin.

In the transesterified oil-and-fat of a lauric-type oil-and-fat and a palm-based oil-and-fat used for the invention, the mixture ratio (mass ratio) of the lauric-type oil-and-fat and the palm-based oil-and-fat (lauric-type oil-and-fat:palm-based oil-and-fat) is preferably 30:70 to 60:40, more preferably 35:65 to 50:50 and further more preferably 35:65 to 45:55.

A transesterification reaction for preparing the Oil-and-fat B used for the invention is not particularly limited, and either a nonselective transesterification or a selective transesterification may be used, but it is preferred to use the nonselective transesterification. In addition, a transesterification method for preparing the Oil-and-fat B used for the invention is not particularly limited, and either a chemical transesterification or an enzymatic transesterification may be used, but it is preferred to use the chemical transesterification. The chemical transesterification can be carried out under the same conditions as the above-mentioned conditions.

The above-mentioned transesterified oil-and-fat of the lauric-type oil-and-fat and the non-lauric-type oil-and-fat includes preferably 10 to 100 mass % of the Oil-and-fat A and 0 to 90 mass % of the Oil-and-fat B, and includes preferably 60 to 100 mass %, more preferably 80 to 100 mass % in a total of the Oil-and-fat A and the Oil-and-fat B.

According to a preferable embodiment, it is preferable that the above-mentioned low melting point fraction obtained by fractionating a non-lauric-type oil-and-fat is a low melting point fraction that has an iodine value of not less than 62, and is obtained by fractionating not less than one oil-and-fat selected from the group consisting of a palm-based oil-and-fat and a transesterified oil-and-fat including a palm-based oil-and-fat as a raw material, and as the other embodiment, it is preferable that the low melting point fraction is a low melting point fraction including not less than 50 mass % of the StU2. In addition, it is preferable that the above-mentioned low melting point fraction obtained by fractionating a non-lauric-type oil-and-fat satisfies the following requirements (α) to (δ).

(α): a S3 content being not more than 5 mass %;
(β): a S2U content being 10 to 40 mass %;
(γ): a SU2 content being 45 to 75 mass %; and
(δ): a U3 content being 5 to 20 mass %.

As the above-mentioned low melting point fraction obtained by fractionating u a non-lauric-type oil-and-fat, more specifically, an oil-and-fat C, an oil-and-fat D and an oil-and-fat E explained below can be included.

It is preferable that the above-mentioned low melting point fraction obtained by fractionating a non-lauric-type oil-and-fat includes the Oil-and-fat C as one embodiment thereof. In the invention, the Oil-and-fat C means a low melting point fraction that has an iodine value of not less than 62 and is obtained by fractionating palm oil or fractionated palm oil, or the mixture oil of them. It is preferable that low melting point part having an iodine value of not less than 62 is a low melting point fraction (palm super olein) obtained by fractionating palm oil not less than two times. As the fractionation method, a dry fractionation, an emulsion fractionation (wet fractionation), a solvent fractionation and so on that are usually used for fractionation of a palm-based oil-and-fat can be appropriately used.

It is preferable that the above-mentioned low melting point fraction obtained by fractionating a non-lauric-type oil-and-fat includes the Oil-and-fat D as one embodiment thereof. In the invention, it is preferable that the Oil-and-fat D is a low melting point fraction that has an iodine value of not less than 62 and is obtained by fractionating a transesterified oil-and-fat including not less than 40 mass % of the palm-based oil-and-fat as a raw material, or a low melting point fraction that has an iodine value of not less than 62 and is obtained by fractionating a mixture oil-and-fat of 40 to 90 mass % of the above-mentioned transesterified oil-and-fat and 10 to 60 mass % of the palm-based oil-and-fat. As the fractionation method, the same method as the above-mentioned method can be appropriately used.

It is preferable that the above-mentioned low melting point fraction obtained by fractionating a non-lauric-type oil-and-fat includes the Oil-and-fat E as one embodiment thereof. In the invention, the Oil-and-fat E means an oil-and-fat that includes not less than 50 mass % of the StU2. Here, the St represents stearic acid, the U represents an unsaturated fatty acid having a carbon number of not less than 16 and the StU2 represents a triacylglycerol configured such that one molecule of St and two molecules of U are bonded. As specific examples of the Oil-and-fat E, a low melting point fraction can be included, the low melting point fraction being obtained by fractionating an oil-and-fat including 30 mass % of StOSt (1,3-distearoyl-2-oleoylglycerol) such as sal fat, shea butter, Moller butter, mango kernel oil, Alan Brassens Kia butter and Pentadesuma butter and so on that are raw material oil-and-fats of cacao butter substitutes. In addition, the oil-and-fat including 30 mass % of the StOSt may be an oil-and-fat obtained by transesterifying a mixture of high oleic sunflower oil and stearic acid ethyl ester by using 1,3-position-selective lipase preparation, based on known methods, so as to remove the fatty acid ethyl ester by distillation. As the fractionation method, the same method as the above-mentioned method can be appropriately used. It is also preferable that the Oil-and-fat E has an iodine value of not less than 62.

It is preferable that the oil-and-fat used for the baked confectionery constituting the combined confectionery of the invention includes 4 to 60 mass % of not less than one selected from the group consisting of the above-mentioned Oil-and-fat A and Oil-and-fat B, and 40 to 96 mass % of not less than one selected from the group consisting of the above-mentioned Oil-and-fat C, Oil-and-fat D and Oil-and-fat E.

The oil-and-fat used for the baked confectionery constituting the combined confectionery of the invention may include blended components other than the oil-and-fats so as to be configured as an oil-and-fat composition. As the other components, food materials and food additives can be included, the food materials and food additives being, for example, water; emulsifiers; thickening stabilizers; salty taste enhancers such as salt, potassium chloride; acidulants such as acetic acid, lactic acid, gluconic acid; sweeteners such as sugars, sugar alcohols, stevia, aspartame; coloring material such as β-carotene, caramel, red yeast of dyes; antioxidants such as tocopherol, tea extract (catechin and the like), rutin; vegetable proteins such as wheat protein, soy protein; eggs; processed egg products; perfumes; dairy products such as whole milk powder, skim milk powder, whey proteins; seasoning; pH adjusting agents; food preservatives; fruit; fruit juice; coffee; nut paste; spices; cocoa mass; cocoa powder; grains; beans; vegetables; meat; seafood. The oil-and-fat composition includes preferably not less than 40 mass %, more preferably not less than 60 mass %, further more preferably not less than 80 mass %, and the most preferably 90 to 100 mass %, of the oil-and-fat used for the baked confectionery constituting the combined confectionery of the invention.

The baked confectionery constituting the combined confectionery of the invention is obtained by baking a baked confectionery dough mainly composed of cereal flour. Here, the cereal flour obtained by grinding grains can be used without any particular limitation, as long as the flour is usually blended into the baked confectionery dough. As specific examples of the cereal flour, wheat flour (strong flour, medium flour, soft flour and the like), barley flour, rice flour, corn flour, rye flour, buckwheat flour, soy flour, and the like can be included.

The oil-and-fat used for the baked confectionery constituting the combined confectionery of the invention can be particularly used for a coating or kneading of the baked confectionery dough. In case of using for kneading into the dough, it is preferable that the oil-and-fat or the oil-and-fat composition including components other than the oil-and-fat is used for kneading into the dough as a plastic oil-and-fat or a plastic oil-and-fat composition which is plasticized by quick cooling-kneading by a conventional method after heating and melting. In case of using for coating the baked confectionery, it is preferable that the oil-and-fat or the oil-and-fat composition including components other than the oil-and-fat is used for coating the baked confectionery by applying a spraying, a brushing, an dipping or the like thereto after heating and melting.

Usage of the oil-and-fat used for the baked confectionery constituting the combined confectionery of the invention to the baked confectionery is not particularly limited, since it varies depending on the type of the baked confectionery, but for example, in case of kneading into the dough of the baked confectionery, with respect to 100 parts by mass of the cereal flour which is blended into the dough, as the net amount of the oil-and-fat, it is preferably 0.5 to 200 parts by mass, more preferably 2 to 150 parts by mass, further more preferably 5 to 100 parts by mass. In addition, in case of coating the baked confectionery, with respect to the baked confectionery, it is preferably 0.5 to 50 parts by mass, more preferably 1 to 30 parts by mass, further more preferably 2 to 20 parts by mass.

The baked confectionery constituting the combined confectionery of the invention may include blended components other than the oil-and-fat and the cereal flour as long as the components are usually blended into the baked confectionery, the components can be used without any particular limitation. In addition, the blending amount of these components can be also used within the range of being usually blended in the baked confectionery and without any particular limitation. Specifically, water, sugar, sugar alcohol, eggs, processed egg products, starch, salt, plastic fat, emulsifier, emulsifying foaming agent (emulsified oil-and-fats), cheese, fresh cream, synthetic cream, yogurt, whole milk powder, skim milk powder, milk, concentrated milk, synthetic milk, yeast, yeast food, cocoa mass, cocoa powder, chocolate, coffee, tea, green tea, vegetables, fruits, fruit, fruit juice, jam, fruit sauce, meat, seafood, beans, roasted soybean flour, soybean curd, soy milk, soy flour, soy protein, leavening agents, sweeteners, seasonings, spices, coloring, flavoring, and the like can be included.

The baked confectionery constituting the combined confectionery of the invention can be produced by the producing conditions and producing method known in the art except for using the above-mentioned oil-and-fats used for the baked confectionery constituting the combined confectionery of the invention.

As specific examples of the baked confectionery constituting the combined confectionery of the invention, in addition to a general baked confectionery such as biscuits, cookies, crackers, hardtack, pretzels, cut bread, wafers, sable, Langue du chat, macaroon and the like, butter cakes (pound cake, fruit cake, Madeleine, Baumkuchen, castella and the like), sponge cakes (short cake, roll cake, torte, decorated cake, chiffon cake and the like), cream puffed confectionery, fermentation pastry, western style fresh confectionery such as pie and waffle, sweet buns, French bread, stollen, panettone, brioche, donuts, Danish pastry, croissants and the like can be included.

### II. Chocolate

The chocolate constituting the combined confectionery of the invention is a chocolate of which oil-and-fat components satisfy the following requirements (A) and (B):

(A) a SOS content being 40 to 90 mass %; and
(B) the sum of the SU2 and U3 contents (SU2+U3) being 10 to 40 mass %.

In the oil-and-fat in the chocolate constituting the combined confectionery of the invention, the SOS content (requirement (A)) is 40 to 90 mass %, preferably 50 to 85 mass %, and more preferably 60 to 80 mass %. If the SOS content of the oil-and-fat in the chocolate falls within the above-mentioned range, tempering process is easily done, thus whitening on a baked confectionery part and blooming on a chocolate part, the whitening and blooming occurring on a combined confectionery with the lapse of time, can be prevented.

Further, in the invention, the SOS represents a triacylglycerol configured such that oleic acid is bonded to the second position, and a saturated fatty acid having a carbon number of not less than 16 is bonded to the first and third positions, and the two saturated fatty acids S bonded to the triacylglycerol molecule may be mutually the same saturated fatty acid and may be a saturated fatty acid different from each other.

In the oil-and-fat in the chocolate constituting the combined confectionery of the invention, the sum of the SU2 and U3 contents (SU2+U3) (requirement (B)) is 10 to 40 mass %, preferably 11 to 34 mass %, more preferably 12 to 28 mass %, and further more preferably 13 to 24 mass %. If the sum of the SU2 and U3 contents (SU2+U3) of the oil-and-fat in the chocolate falls within the above-mentioned range, whitening on a baked confectionery part and blooming on a chocolate part, the whitening and blooming occurring on a combined confectionery with the lapse of time, can be prevented.

According to a preferable embodiment of the invention, in the oil-and-fat in the chocolate constituting the combined confectionery of the invention, the ratio of mass (SU2/U3) of SU2 to U3 (requirement (C)) is preferably not less than 1, more preferably not less than 2, and further more preferably not less than 4. The upper limit is not particularly specified, but it is difficult to make it 12 in terms of actual producing, and 10 is appropriate. If the ratio of mass (SU2/U3) of SU2 to U3 falls within the above-mentioned range, whitening on a baked confectionery part and blooming on a chocolate part, the whitening and blooming occurring on a combined confectionery with the lapse of time, can be effectively prevented.

According to a preferable embodiment of the invention, in the oil-and-fat in the chocolate constituting the combined confectionery of the invention, the content of StOSt that is one of the SOS and is a triacylglycerol configured such that oleic acid is bonded to the second position and stearic acid is bonded to the first and third positions (requirement (D)) is preferably 27 to 65 mass %, more preferably 34 to 60 mass %, further more preferably 37 to 60 mass %, the most preferably 40 to 55 mass %. If the content of StOSt of the oil-and-fat in the chocolate falls within the above-mentioned range, blooming on a chocolate part in the combined confectionery can be prevented, and simultaneously heat resistance reduced due to including the SU2 and the U3 (SU2+U3) can be heightened without damaging meltability in the mouth.

According to a preferable embodiment of the invention, the oil-and-fat in the chocolate constituting the combined confectionery of the invention includes a trans fatty acid as the constituent fatty acid preferably not more than 5 mass %, more preferably not more than 2 mass %, and further more preferably not more than 1 mass %. If the content of the trans fatty acid falls within the above-mentioned range, it is nutritionally preferable.

The content of the oil-and-fat in the chocolate constituting the combined confectionery of the invention is preferably 20 to 80 mass %, more preferably 25 to 70 mass %, and further more preferably 30 to 60 mass %. Further, the oil-and-fat in the invention, in addition to those blended as oil-and-fats such as cocoa butter, also includes oil-and-fats that are included in the oil-containing raw materials such as cocoa mass including about 55 mass % of cocoa butter, whole milk powder including about 25 mass % of milk fat.

According to a preferable embodiment, if the oil-and-fat in the chocolate constituting the combined confectionery of the invention satisfies the above-mentioned requirements (A) and (B), any oil-and-fat raw material as a raw material oil-and-fat and any processing method may be used. Natural oil-and-fat raw materials may be used individually or in a blend of not less than two materials. In addition, oil-and-fats to which treatments such as fractionation, transesterification, hydrogenation are applied may be used. As preferable oil-and-fat raw materials used for the above-mentioned oil-and-fat, for example, as a supply source of the SOS, cocoa butter, palm oil, fractionated palm oil, shea butter, fractionated shea oil, sal fat, fractionated sal oil, illipe butter, co-Qum butter, mango fat, fractionated mango oil, an oil-and-fat rich in the SOS produced by transesterification and the like are included. In addition, as a supply source of the (SU2+U3), the low melting point fraction obtained by fractionating the non-lauric-type oil-and-fat explained in the oil-and-fat used for the baked confectionery constituting the combined confectionery of the invention may also be used. Furthermore, for example, not less than one of animal and vegetable oil-and-fats such as soybean oil, rapeseed oil, cottonseed oil, safflower oil, sunflower oil, rice oil, corn oil, sesame oil, olive oil, beef tallow, lard, and milk fat, or processed oil-and-fats thereof, can also be used in a mixed state. In addition, the oil-containing raw materials such as cocoa mass and cocoa powder that include cocoa butter, whole milk powder that includes milk fat can also be used. The above-mentioned oil-and-fat rich in the SOS includes preferably not less than 50 mass %, more preferably 60 to 90 mass %, further more preferably 75 to 90 mass % of the SOS. The oil-and-fat rich in the SOS may be a supply source of the SOS included in the oil-and-fat in the chocolate constituting the combined confectionery of the invention.

According to a preferable embodiment of the invention, it is preferable that as a part of the oil-and-fat rich in the SOS, a StOSt oil-and-fat is included in the oil-and-fat in the chocolate constituting the combined confectionery of the invention, the StOSt oil-and-fat being configured such that the content of the StOSt is preferably 50 to 90 mass %, and more preferably 60 to 80 mass %. The ratio of the StOSt oil-and-fat to the oil-and-fat rich in the SOS is preferably 20 to 100 mass %, and more preferably 30 to 90 mass %. It is preferable that the StOSt oil-and-fat includes Oil-and-fat F as one of embodiments. The Oil-and-fat F can be produced by transesterifying by known methods while using an oil-and-fat (for example, high-oleic sunflower oil and the like) rich in a triacylglycerol configured such that oleic acid is bonded to the second position, and stearic acid or stearic acid lower alkyl ester, and using an enzyme preparation having 1, 3-position selectivity so as to obtain a transesterified oil-and-fat, and then by applying a fractionation treatment to the transesterified oil-and-fat so as to separately collect a medium melting point fraction.

Further, in the invention, a treatment such as fractionation, transesterification, hydrogenation can be carried out by using conventionally known methods. The method of transesterification is not particularly limited, and can be carried out by conventionally known methods. For example, either a chemical transesterification that uses a synthesis catalyst such as sodium methoxide or an enzymatic transesterification that uses lipase as a catalyst can be used.

As the oil-and-fat in the chocolate constituting the combined confectionery of the invention, it is preferred to use fractionated palm oil. For example, as the fractionated palm oil, both an olein fraction (liquid fraction) and a stearin fraction (solid fraction) that are obtained by dry-fractionating, solvent-fractionating, or emulsion-fractionating the palm oil can be used. A medium melting point fraction of palm oil such as an olein fraction obtained by further fractionating palm stearin fraction and a stearin fraction obtained by further fractionating palm olein fraction can be a supply source of the SOS included in the above-mentioned oil-and-fat. In addition, an olein fraction (palm super olein) obtained by further fractionating palm olein fraction is a kind of the low melting point fraction obtained by fractionating a non-lauric-type oil-and-fat, and can be a supply source of the (SU2+U3).

It is preferable that the oil-and-fat in the chocolate constituting the combined confectionery of the invention includes the above-mentioned oil-and-fat rich in the SOS and the above-mentioned low melting point fraction obtained by fractionating a non-lauric-type oil-and-fat. The oil-and-fat in the chocolate constituting the combined confectionery of the invention includes preferably 60 to 95 mass %, more preferably 70 to 95 mass %, further more preferably 80 to 90 mass % of the above-mentioned oil-and-fat rich in the SOS. The oil-and-fat in the chocolate constituting the combined confectionery of the invention includes preferably 5 to 40 mass %, more preferably 5 to 30 mass %, further more preferably 10 to 20 mass % of the above-mentioned low melting point fraction obtained by fractionating a non-lauric-type oil-and-fat.

The chocolate constituting the combined confectionery of the invention is not a chocolate that is limited by “Fair competition rules related to the display of chocolates” (Nationwide chocolate industry Fair Trade Council) or the provisions of the law, but is a chocolate that is produced by using edible oil-and-fats and sugars as main raw materials, and adding cocoa components (cocoa mass, cocoa powder and the like), dairy products, flavors, emulsifiers and the like thereto, if necessary, via a part or the whole of the usual chocolate producing process (a mixing process, an refining process, a conching process, a molding process, a cooling process and the like). In addition, the chocolate in the invention includes, in addition to a dark chocolate and a milk chocolate, a white chocolate and a color chocolate. It is preferable that the chocolate according to the embodiment is a tempering type chocolate.

As raw materials other than oil-and-fats of the chocolate constituting the combined confectionery of the invention, food ingredients conventionally known can be used without any particular limitation, as long as the food ingredients are usually used when the chocolate is produced. For example, saccharides such as saccharose (sugar, powdered sugar), lactose, glucose, fructose, maltose, hydrogenated starch saccharide, liquid sugar, enzymatic conversion syrup, isomerized liquid sugars, saccharose bond syrup, reducing sugar polydextrose, oligosaccharide, sorbitol, reduction lactose, trehalose, xylose, xylitol, maltitol, erythritol, mannitol, raffinose, and dextrin; dairy products such as whole milk powder, skim milk powder; cocoa mass; cocoa powder; soy flour; soy protein; fruit processed products; vegetable processed products; various powders such as green tea powder, coffee powder; gums; and starch can be included. In addition, additives can be used, as long as the additives are usually used for the chocolate. As the additives, emulsifiers (lecithin, lysolecithin, enzyme-decomposed lecithin, saccharose fatty acid esters, polyglycerol condensed ricinoleic acid ester, polyglycerol fatty acid esters, sorbitan fatty acid esters and the like), antioxidants, colorants, and flavors (vanilla flavor and the like) and the like can be included.

The chocolate constituting the combined confectionery of the invention includes preferably 20 to 80 mass %, more preferably 30 to 75 mass %, further more preferably 40 to 70 mass % of saccharides.

The shape of the chocolate constituting the combined confectionery of the invention is not be particularly limited, for example, shaped chocolate like plate, block, chip, chunk, granular, and coating chocolate can be used.

A method of producing the chocolate constituting the combined confectionery of the invention is not particularly limited, and the methods conventionally known can be used. As an example, the chocolate can be produced by mixing raw material oil-and-fats (the above-mentioned oil-and-fat rich in the SOS, the above-mentioned low melting point fraction obtained by fractionating a non-lauric-type oil-and-fat, cocoa butter and the like), cocoa mass, lecithin, whole milk powder, vanilla perfume, powdered sugar and the like, and by carrying out the processes such as refining by rolling, conching, tempering, and filling and molding.

### III. Combined Confectionery

The combined confectionery of the invention is characterized in that the above-mentioned baked confectionery constituting the combined confectionery of the invention and the above-mentioned chocolate constituting the combined confectionery of the invention are combined with each other. As long as the baked confectionery and the chocolate used for the invention are brought into contact with each other, the combination method thereof in the combined confectionery of the invention is not particularly limited, and can include bonding, coating, sandwiching, filling, embedding, topping and the like.

The combined confectionery of the invention can be produced by a method similar to the usual producing method of the combined confectionery, except for using the baked confectionery and the chocolate used for the invention. For example, the combined confectionery can be produced by combining the baked confectionery preliminarily baked with the chocolate preliminarily prepared, due to bonding, coating, sandwiching, filling, topping and the like, by baking the baked confectionery dough to which spreading, stuffing, coating or topping of the chocolate preliminarily prepared is applied, or by carrying out the similar processing.

The combined confectionery of the invention is a combined confectionery in which whitening on a baked confectionery part and blooming on a chocolate part, the whitening and blooming occurring with the lapse of time, are prevented.

### EXAMPLES

Hereinafter, the invention will be explained in detail by Examples and Comparative Examples. However, the invention is not intended to be limited to these Examples in any way.

<Method of Measurement>

Measurement of each fatty acid content, each triacylglycerol content and an iodine value of the oil-and-fats described below were measured by the following method.

Each fatty acid content was measured by a gas chromatography method.

Each triacylglycerol content was measured by a gas chromatography method. The symmetry of the triacylglycerol was measured by silver ion column chromatography method.

The iodine value was measured in accordance with “Japan Oil Chemists' Society: The JOCS Standard Methods for the analysis of Fats, Oils and Related Materials 2. 3. 4. 1-1996 Iodine Value (Wijs-cyclohexane method)”.

<Preparation of Oil-and-Fat A-1>

A mixture oil-and-fat obtained by mixing 50 parts by mass of a palm stearin (a product manufactured by the Nisshin OilliO Group, Ltd.) and 50 parts by mass of a palm kernel olein (a product manufactured by the Nisshin OilliO Group, Ltd.) was sufficiently dried by heat under reduced pressure at 120 degrees C., and then, 0.1 mass % of sodium methylate with respect to the oil-and-fat was added, and a transesterification reaction was carried out at 110 degrees C., for 0.5 hour, under reduced pressure while stirring. After completion of the transesterification reaction, sodium methylate was removed by water washing, and decolorization was carried out, and then a hydrogenation was carried out by using a nickel catalyst at 160 to 200 degrees C. so as to adjust the iodine value to be not more than 2. After confirming that the iodine value became not more than 2, the temperature was lowered to not more than 100 degrees C., the nickel catalyst was removed by filtration, and decolorization and deodorization were performed according to a conventional refining method, so that the oil-and-fat A-1 (the content of saturated fatty acids having a carbon number of 12 to 14: 31.0 mass %, the content of saturated fatty acids having a carbon number of 16 to 18: 64.7 mass %, the content of unsaturated fatty acids: 1.4 mass %, the iodine value: 0.1) was obtained.

<Preparation of Oil-and-Fat B-1]>

A mixture oil-and-fat obtained by mixing 40 parts by mass of a palm kernel oil (a product manufactured by the Nisshin OilliO Group, Ltd.) and 60 parts by mass of a palm oil (a product manufactured by the Nisshin OilliO Group, Ltd.) was sufficiently dried by heat under reduced pressure at 120 degrees C., and then, 0.2 mass % of sodium methylate with respect to the oil-and-fat was added, and a transesterification reaction was carried out at 110 degrees C., for 0.5 hour, under reduced pressure while stirring. After completion of the transesterification reaction, sodium methylate was removed by water washing, and decolorization and deodorization were performed according to a conventional refining method, so that the oil-and-fat B-1 (the content of saturated fatty acids having a carbon number of 12 to 14: 26.0 mass %, the content of saturated fatty acids having a carbon number of 16 to 18: 33.6 mass %, the content of unsaturated fatty acids: 37.6 mass %, the iodine value: 39) was obtained.

<Preparation of Oil-and-Fat C-1>

A palm super olein (a product manufactured by the Nisshin OilliO Group, Ltd., the iodine value: 65.2, the content of S3: 0.1 mass %, the content of S2U: 29.9 mass %, the content of SU2: 57.0 mass %, the content of U3: 8.4 mass %, the content of StU2: 5.5 mass %) was defined as the Oil-and-fat C-1.

<Preparation of Oil-and-Fat D-1>

(Preparation of Transesterified Oil-and-Fat d-1)

22 parts by mass of high oleic sunflower oil, 31 parts by mass of palm stearin (the iodine value: 36.1) and 47 parts by mass of fully hydrogenated oil of soybean oil were mixed. The mixture oil-and-fat obtained was sufficiently dried by heat under reduced pressure at 120 degrees C., and then, 0.1 mass % of sodium methylate with respect to the oil-and-fat was added, and a transesterification reaction was carried out at 110 degrees C., for 0.5 hour, under reduced pressure while stirring, so that the transesterified oil-and-fat d-1 was obtained.

(Preparation of Transesterified Oil-and-Fat d-2)

60 parts by mass of palm stearin (the iodine value: 36.1) and 40 parts by mass of palm oil (the iodine value: 52.0) were mixed. The mixture oil-and-fat obtained was sufficiently dried by heat under reduced pressure at 120 degrees C., and then, 0.1 mass % of sodium methylate with respect to the oil-and-fat was added, and a transesterification reaction was carried out at 110 degrees C., for 0.5 hour, under reduced pressure while stirring, so that the transesterified oil-and-fat d-2 was obtained.

(Fractionation of Transesterified Oil-and-Fat)

40 parts by mass of the transesterified oil-and-fat d-1 and 60 parts by mass of the transesterified oil-and-fat d-2 were mixed. A dry-fractionation was applied to the mixture oil-and-fat obtained at 36 to 38 degrees C., and the high melting point fraction was removed, so that the low melting point fraction was obtained. A solvent fractionation (acetone was used) was applied to the low melting point fraction obtained at 0 to 2 degrees C., and the high melting point fraction was removed, so that the low melting point fraction was obtained. Decolorization and deodorization were applied according to a conventional refining method to the low melting point fraction obtained, so that the oil-and-fat D-1 (the iodine value: 64.4, the content of S3: 0.1 mass %, the content of S2U: 28.4 mass %, the content of SU2: 55.4 mass %, the content of U3: 10.9 mass %, the content of StU2: 11.7 mass %) was obtained.

<Preparation of Oil-and-Fat E-1>

40 parts by mass of high oleic sunflower oil, and 60 parts by mass of ethyl stearate were mixed and the 1, 3-position-selective lipase preparation was added thereto, so that the transesterification reaction was carried out. The lipase preparation was removed by filtration, and the reactant obtained was subjected to a thin-film distillation, thereby the fatty acid ethyl ester was removed from the reactant, so that distillation residue was obtained. From the distillation residue obtained, the high melting point fraction was removed by dry fractionation, and from the low melting point fraction obtained, the second stage high melting point fraction was removed by acetone fractionation, so that the low melting point fraction was obtained. Acetone removal, decolorization and deodorization were applied according to a conventional method to the low melting point fraction obtained, so that the oil-and-fat E-1 (the iodine value: 63.9, the content of S3: 0.3 mass %, the content of S2U: 11.6 mass %, the content of SU2: 67.8 mass %, the content of U3: 17.5 mass %, the content of StU2: 61.9 mass %) was obtained.

<Preparation of Oil-and-Fat F-1>

40 parts by mass of high oleic sunflower oil, and 60 parts by mass of ethyl stearate were mixed and the 1, 3-position-selective lipase preparation was added thereto, so that the transesterification reaction was carried out. The lipase preparation was removed by filtration, and the reactant obtained was subjected to a thin-film distillation, thereby the fatty acid ethyl ester was removed from the reactant, so that distillation residue was obtained. From the distillation residue obtained, the high melting point part was removed by dry fractionation, and from the low melting point part obtained, the second stage low melting point part was removed by acetone fractionation, so that the medium melting point part was obtained. Acetone removal, decolorization and deodorization were applied according to a conventional method to the medium melting point part obtained, so that the oil-and-fat F-1 (the content of SOS: 82.4 mass %, the content of StOSt: 67.3 mass %, the content of SU2: 8.8 mass %, the content of U3: 1.2 mass %) was obtained.

<The Other Oil-and-Fats>

(Preparation of Transesterified Oil-and-Fat I)

Palm olein (the iodine value: 56, a product manufactured by the Nisshin OilliO Group, Ltd.) was sufficiently dried by heat under reduced pressure at 120 degrees C., and then, 0.1 mass % of sodium methylate with respect to the oil-and-fat was added, and a transesterification reaction was carried out at 110 degrees C., for 0.5 hour, under reduced pressure while stirring. After completion of the transesterification reaction, sodium methylate was removed by water washing, and decolorization and deodorization were performed according to a conventional refining method, so that the transesterified oil-and-fat I (the iodine value: 56) was obtained.

(Palm Olein)

Palm olein (the iodine value: 56, a product manufactured by the Nisshin OilliO Group, Ltd.) was used.

(Palm Stearin)

Palm stearin (the iodine value: 35, a product manufactured by the Nisshin OilliO Group, Ltd.) was used.

(Fully Hydrogenated Palm Oil)

Fully hydrogenated palm oil (the iodine value: not more than 2, a product manufactured by Yokozeki Oil & Fat Industries Co., Ltd.) was used.

(Rapeseed Oil)

Refined rapeseed oil (Shirashime oil, a product manufactured by the Nisshin Oillio Group, Ltd.) was used.

(Cocoa Butter)

Cocoa butter (a product manufactured by Daito Cacao Co., Ltd.) was used.

<Preparation I of Baked Confectionery>

According to the formulation of the raw material oil-and-fat shown in Tables 1 and 2, each oil-and-fat of Examples 1 to 8 for baked confectionery was prepared, 0.6 parts by mass of the emulsifier was added with respect to 99.4 parts by mass of each oil-and-fat, so as to be dissolved and mixed, and then quick cooling and kneading for plasticization was applied thereto by using Onlator, thereby each oil-and-fat composition (shortening) of Examples 1 to 8 was prepared.

A cookie of the formulation shown in Table 3 was prepared by using each shortening of Examples 1 to 8. Namely, sugar was added to each shortening softened, and mixed well. Then whole egg was added in several times to avoid separation. Shifted flour was added to the mixture to prepared dough. After refrigerating the dough at rest, the dough was expanded by a roller so as to be a thickness of 3 mm, and was cut out with circular cutter having a diameter of 3 cm, and was baked in an oven for 8 minutes, at 180 degrees C. of upper fire and at 160 degrees C. of lower fire, thereby each cookie of Examples 1 to 8 was obtained.

TABLE 1
Oil-and-fat formulation of oil-and-fat for baked confectionery (mass %)
TAG content (mass %), TAG mass ratio and trans fatty acid
content (mass %) of the oil-and-fat

| | | Exam- | Exam- | Exam- | Exam- |
|---|---|---|---|---|---|
| | | ple 1 | ple 2 | ple 3 | ple 4 |
| Oil-and-fat | Oil-and-fat A-1 | 10 | 10 | 10 | 10 |
| formulation | Oil-and-fat B-1 | — | — | 20 | — |
| | Oil-and-fat C-1 | 90 | — | 70 | 50 |
| | Oil-and-fat D-1 | — | 90 | — | — |
| | Palm olein | — | — | — | 40 |
| Total | | 100 | 100 | 100 | 100 |
| TAG content | CN 40 to 46 | 5.0 | 5.0 | 14.5 | 5.0 |
| (mass %) and | S2U + SU2 | 78.2 | 75.4 | 65.0 | 79.7 |
| TAG mass | S3 | 2.5 | 2.5 | 3.3 | 3.1 |
| ratio | U3 | 7.6 | 9.8 | 6.5 | 6.5 |
| | SU2/(S2U + | 0.65 | 0.66 | 0.64 | 0.57 |
| | SU2) | | | | |
| | USU/SU2 | 0.03 | 0.27 | 0.11 | 0.03 |
| | StU2 | 5.0 | 10.5 | 4.1 | 4.4 |

| | | | | |
|---|---|---|---|---|
| Trans fatty acid | 0.9 | 0.9 | 0.8 | 0.8 |

TABLE 2
Oil-and-fat formulation of oil-and-fat for baked confectionery (mass %)
TAG content (mass %), TAG mass ratio and trans fatty acid
content (mass %) of the oil-and-fat

| | | Exam- | Exam- | Exam- | Exam- |
|---|---|---|---|---|---|
| | | ple 5 | ple 6 | ple 7 | ple 8 |
| Oil-and-fat | Oil-and-fat A-1 | — | — | 10 | 10 |
| formulation | Oil-and-fat B-1 | — | — | — | — |
| | Oil-and-fat C-1 | 90 | — | — | 40 |
| | Oil-and-fat D-1 | — | — | — | — |
| | Palm olein | — | — | 90 | — |
| | Transesterified | — | 100 | — | — |
| | oil-and-fat I | | | | |
| | Fully | 10 | — | — | — |
| | hydrogenated | | | | |
| | palm oil | | | | |
| | Rapeseed oil | — | — | — | 50 |
| Total | | 100 | 100 | 100 | 100 |
| TAG content | CN 40 to 46 | 0.3 | 1.0 | 5.0 | 5.0 |
| (mass %) and | S2U + SU2 | 78.2 | 74.3 | 81.5 | 42.5 |
| TAG mass | S3 | 11.2 | 11.4 | 3.8 | 2.5 |
| ratio | U3 | 7.6 | 12.6 | 5.1 | 43.4 |
| | SU2/(S2U + | 0.65 | 0.51 | 0.51 | 0.70 |
| | SU2) | | | | |
| | USU/SU2 | 0.03 | 0.32 | 0.03 | 0.01 |
| | StU2 | 5.0 | 3.3 | 3.7 | 2.2 |

| | | | | |
|---|---|---|---|---|
| Trans fatty acid | 0.9 | 0.8 | 0.7 | 1.0 |

TABLE 3
Formulation of cookie (part by mass)

| | |
|---|---|
| Oil-and-fat composition | 50 |
| Sugar | 50 |
| Whole egg | 20 |
| Flour | 100 |

<Preparation I of Chocolate>

According to the formulation shown in Table 4, chocolates of Examples 9 to 10 were prepared. Namely, by the blending ratio shown in the Table 4, oil-and-fats and the other raw materials were mixed with each other. Subsequently, according to the conventional method, refining, conching and tempering were carried out, so that the chocolates of Examples 9 to 10 formed in a shape of 36.5 mm (length) by 38 mm (width) by 3 mm (thickness) were obtained.

TABLE 4
Formulation of chocolate (mass %)
TAG content (mass %) and TAG mass ratio of oil-and-fat in the chocolate

| | Example 9 | Example 10 |
|---|---|---|
| Cocoa mass | 37.8 | 37.8 |
| Cacao butter | 14.2 | — |
| Oil-and-fat E-1 | — | 4.2 |
| Oil-and-fat F-1 | — | 10.0 |
| Sugar | 47.45 | 47.45 |
| Lecithin | 0.5 | 0.5 |
| Flavor | 0.05 | 0.05 |
| Total | 100.0 | 100.0 |
| Oil-and-fat content of chocolate | 35 | 35 |
| Each TAG content, composition ratio of | | |
| oil-and-fat in the chocolate | | |
| SOS content | 86.1 | 75.7 |
| StOSt content | 29.1 | 37.0 |
| SU2 content | 4.9 | 13.6 |
| U3 content | 0.2 | 3.3 |
| SU2 + U3 content | 5.1 | 16.9 |
| SU2/U3 | 25.5 | 4.1 |

<Evaluation I of Combined Confectionery>

Combined confectioneries of Examples 11 to 26 were obtained from each cookie (baked confectionery) of Examples 1 to 8 and each chocolate of Examples 9 to 10, by placing the cookie on the chocolate formed in a plate-like shape and adhering the bottom surface of the cookie to the chocolate. The combined confectioneries obtained were preserved at 30 degrees C. for 2 weeks. Whitening on the cookie and blooming on the chocolate in the combined confectioneries after the completion of the preservation were evaluated by the following evaluation criteria by visual observation. The evaluation of whitening and blooming was judged as good in case of a double circle mark (⊚) or a single circle mark (∘). The evaluation result was shown in Tables 5 to 8. Examples 11 to 18, 23, 24 and 26 are Comparative Examples.

<Evaluation Criteria of Whitening>

⊚: Whitening was not found.

∘: Whitening was not found but color unevenness was slightly found in surface.

Δ: Whitening was partly found.

x: Whitening was found.

<Evaluation Criteria of Blooming>

⊚: Blooming was not found.

∘: Blooming was not found but gloss was slightly lost.

Δ: Blooming was partly found.

x: Blooming was found.

TABLE 5

| | | Exam- | Exam- | Exam- | Exam- |
|---|---|---|---|---|---|
| | | ple 11 | ple 12 | ple 13 | ple 14 |
| | | (Compar- | (Compar- | (Compar- | (Compar- |
| | | ison) | ison) | ison) | ison) |
| Used baked | | Exam- | Exam- | Exam- | Examp- |
| confectionery | | ple 1 | ple 2 | ple 3 | le 4 |
| Used chocolate | | Exam- | Exam- | Exam- | Examp- |
| | | ple 9 | ple 9 | ple 9 | le 9 |
| Evaluation | Whitening | Δ | Δ | Δ | X |
| result | Blooming | X | Δ | Δ | X |

TABLE 6

| | | Exam- | Exam- | Exam- | Exam- |
|---|---|---|---|---|---|
| | | ple 15 | ple 16 | ple 17 | ple 18 |
| | | (Compar- | (Compar- | (Compar- | (Compar- |
| | | ison) | ison) | ison) | ison) |
| Used baked | | Exam- | Exam- | Exam- | Exam- |
| confectionery | | ple 5 | ple 6 | ple 7 | ple 8 |
| Used chocolate | | Exam- | Exam- | Exam- | Exam- |
| | | ple 9 | ple 9 | ple 9 | ple 9 |
| Evaluation | Whitening | X | X | X | X |
| result | Blooming | X | X | X | X |

TABLE 7

| | | Exam- | Exam- | Exam- | Exam- |
|---|---|---|---|---|---|
| | | ple 19 | ple 20 | ple 21 | ple 22 |
| Used baked | | Exam- | Exam- | Exam- | Exam- |
| confectionery | | ple 1 | ple 2 | ple 3 | ple 4 |
| Used chocolate | | Exam- | Exam- | Exam- | Exam- |
| | | ple 10 | ple 10 | ple 10 | ple 10 |
| Evaluation | Whitening | ⊚ | ⊚ | ⊚ | ⊚ |
| result | Blooming | ◯ | ⊚ | ⊚ | ◯ |

TABLE 8

| | | Exam- | Exam- | | Exam- |
|---|---|---|---|---|---|
| | | ple 23 | ple 24 | | ple 26 |
| | | (Compar- | (Compar- | Exam- | (Compar- |
| | | ison) | ison) | ple 25 | ison) |
| Used baked | | Exam- | Exam- | Exam- | Exam- |
| confectionery | | ple 5 | ple 6 | ple 7 | ple 8 |
| Used chocolate | | Exam- | Exam- | Exam- | Exam- |
| | | ple 10 | ple 10 | ple 10 | ple 10 |
| Evaluation | Whitening | Δ | Δ | ◯ | X |
| result | Blooming | X | Δ | ◯ | Δ |

<Preparation II of Baked Confectionery>

According to the formulation of the raw material oil-and-fat shown in Table 9, each oil-and-fat of Examples 27 to 30 for baked confectionery was prepared.

Each oil-and-fat of Examples 27 to 30 for baked confectionery was heated and melted, and 10 mass % thereof with respect to biscuits were spray-coated on the biscuits, so that the biscuits of Examples 27 to 30 were obtained. The biscuits were produced according to the formulation shown in Table 10. Namely, wheat flour, sugar, salt, and flavor were mixed with each other, and further commercially available shortening was added thereto, so as to be ground together. Combine and dissolve water, whole egg, and sodium bicarbonate, and add the liquid to the mixture, then mix well to obtain a soft dough. After refrigerating the dough at rest, the dough was expanded by a roller so as to be a thickness of 3 mm, and was cut out with a circular cutter having a diameter of 3 cm, and was baked in an oven for 8 minutes, at 200 degrees C. of upper fire and at 180 degrees C. of lower fire, thereby the biscuits of Examples 27 to 30 were obtained.

TABLE 9
Oil-and-fat formulation of oil-and-fat for baked confectionery (mass %)
TAG content (mass %), TAG mass ratio and trans fatty acid
content (mass %) of the oil-and-fat

| | | Exam- | Exam- | Exam- | Exam- |
|---|---|---|---|---|---|
| | | ple 27 | ple 28 | ple 29 | ple 30 |
| Oil-and-fat | Oil-and-fat A-1 | 25 | 35 | — | 2 |
| formulation | Oil-and-fat C-1 | — | 65 | — | — |
| | Oil-and-fat E-1 | 75 | — | 100 | 68 |
| | Transesterified | — | — | — | — |
| | oil-and-fat I | | | | |
| | Palm stearin | — | — | — | 30 |
| Total | | 100 | 100 | 100 | 100 |
| TAG content | CN 40 to 46 | 12.5 | 17.5 | 0.0 | 1.4 |
| (mass %) and | S2U + SU2 | 59.6 | 56.5 | 79.4 | 71.6 |
| TAG mass | S3 | 6.3 | 8.8 | 0.3 | 10.7 |
| ratio | U3 | 13.1 | 5.5 | 17.5 | 12.6 |
| | SU2/(S2U + | 0.85 | 0.65 | 0.85 | 0.72 |
| | SU2) | | | | |
| | USU/SU2 | 0.02 | 0.03 | 0.02 | 0.03 |
| | StU2 | 46.4 | 3.5 | 61.9 | 42.6 |

| | | | | |
|---|---|---|---|---|
| Trans fatty acid | 0.2 | 0.1 | 0.7 | 0.3 |

TABLE 10
Formulation of biscuit (part by mass)

| | |
|---|---|
| Flour | 100 |
| Shortening | 15 |
| Sugar | 25 |
| Water | 20 |
| Whole egg | 4 |
| Sodium bicarbonate | 1.0 |
| Flavor | 0.1 |

<Preparation II of Chocolate>

According to the formulation shown in Table 11, chocolates of Examples 31 to 32 were prepared. Namely, by the blending ratio shown in the Table 11, oil-and-fats and the other raw materials were mixed with each other. Subsequently, according to the conventional method, refining, conching and tempering (seeding) were carried out, so that the chocolates of Examples 31 to 32 formed in a shape of 36.5 mm (length) by 38 mm (width) by 3 mm (thickness) were obtained.

TABLE 11
Formulation of chocolate (mass %)
TAG content (mass %) and TAG mass ratio of oil-and-fat in the chocolate

| | Example 31 | Example 32 |
|---|---|---|
| Cocoa mass | 20.8 | 2.6 |
| Cacao butter | 0.6 | 9.8 |
| Whole milk powder | 12.0 | 12.0 |
| Oil-and-fat C-1 | — | 4.0 |
| Oil-and-fat F-1 | 20.0 | 24.0 |
| Fully hydrogenated palm oil | 0.5 | 1.5 |
| Powdered sugar | 45.55 | 45.55 |
| Lecithin | 0.5 | 0.5 |
| Flavor | 0.05 | 0.05 |
| Total | 100.0 | 100.0 |
| Oil-and-fat content of chocolate | 35 | 35 |
| Each TAG content, composition ratio of | | |
| oil-and-fat in the chocolate | | |
| SOS content | 75.4 | 65.0 |
| StOSt content | 48.0 | 48.2 |
| SU2 content | 7.2 | 14.2 |
| U3 content | 0.9 | 2.1 |
| SU2 + U3 content | 8.1 | 16.3 |
| SU2/U3 | 8.0 | 6.7 |

<Evaluation II of Combined Confectionery>

Combined confectioneries of Examples 33 to 40 were obtained from each biscuit (baked confectionery) of Examples 27 to 30 and each chocolate of Examples 31 to 32, by placing the biscuit on the chocolate formed in a plate-like shape and adhering the bottom surface of the biscuit to the chocolate. The combined confectioneries obtained were preserved by repeating 3 cycles, as one cycle being at 37 degrees C. for 12 hours and at 20 degrees C. for 12 hours. Whitening on the cookie and blooming on the chocolate in the combined confectioneries after the completion of the preservation were evaluated by the following evaluation criteria by visual observation. The evaluation of whitening and blooming was judged as good in case of a double circle mark (⊚) or a single circle mark (∘). The evaluation result was shown in Tables 12 to 13. Examples 33 to 36, 39 and 40 are Comparative Examples.

<Evaluation Criteria of Whitening>

⊚: Whitening was not found.

∘: Whitening was not found but color unevenness was slightly found in surface.

Δ: Whitening was partly found.

x: Whitening was found.

<Evaluation Criteria of Blooming>

⊚: Blooming was not found.

∘: Blooming was not found but gloss was slightly lost.

Δ: Blooming was partly found.

x: Blooming was found.

TABLE 12

| | | Exam- | Exam- | Exam- | Exam- |
|---|---|---|---|---|---|
| | | ple 33 | ple 34 | ple 35 | ple 36 |
| | | (Compar- | (Compar- | (Compar- | (Compar- |
| | | ison) | ison) | ison) | ison) |
| Used baked | | Exam- | Exam- | Exam- | Exam- |
| confectionery | | ple 27 | ple 28 | ple 29 | ple 30 |
| Used chocolate | | Exam- | Exam- | Exam- | Exam- |
| | | ple 31 | ple 31 | ple 31 | ple 31 |
| Evaluation | Whitening | Δ | Δ | Δ | X |
| result | Blooming | Δ | ◯ | X | X |

TABLE 13

| | | | | Exam- | Exam- |
|---|---|---|---|---|---|
| | | | | ple 39 | ple 40 |
| | | Exam- | Exam- | (Compar- | (Compar- |
| | | ple 37 | ple 38 | ison) | ison) |
| Used baked | | Exam- | Exam- | Exam- | Exam- |
| confectionery | | ple 27 | ple 28 | ple 29 | ple 30 |
| Used chocolate | | Exam- | Exam- | Exam- | Exam- |
| | | ple 32 | ple 32 | ple 32 | ple 32 |
| Evaluation | Whitening | ⊚ | ◯ | ◯ | Δ |
| result | Blooming | ⊚ | ⊚ | X | X |

1. A combined confectionery that comprises a combination of a baked confectionery using an oil-and-fat which satisfies the following requirements (a), (b) and (c) with a chocolate of which oil-and-fat components satisfy the following requirements (A) and (B):
(a) a CN 40 to 46 content being 2 to 30 mass %;
(b) the sum of S2U and SU2 contents (S2U+SU2) being 45 to 85 mass %;
(c) the ratio of mass of SU2 to (S2U+SU2) [SU2/(S2U+SU2)] being not less than 0.50;
(A) a SOS content being 40 to 90 mass %; and
(B) the sum of the SU2 and U3 contents (SU2+U3) being 10 to 40 mass %,
provided that the CN 40 to 46, S, U, O, S2U, SU2, SOS and U3 represent the following compounds respectively:
CN 40 to 46: a triacylglycerol configured such that the total carbon number of the fatty acid residue constituting the triacylglycerol being 40 to 46;
S: a saturated fatty acid having a carbon number of not less than 16;
U: an unsaturated fatty acid having a carbon number of not less than 16;
O: oleic acid;
S2U: a triacylglycerol configured such that two molecules of S and one molecule of U are bonded;
SU2: a triacylglycerol configured such that one molecule of S and two molecules of U are bonded;
SOS: a triacylglycerol configured such that S is bonded to the first and third positions and O is bonded to the second position; and
U3: a triacylglycerol configured such that three molecules of U are bonded.

2. The combined confectionery according to claim 1, wherein
the oil-and-fat used for the baked confectionery satisfies the following requirements (d) and (e),
(d): a S3 content being not more than 15 mass %; and
(e): a U3 content being not more than 18 mass %,
provided that the S3 represents the following compound:
S3: a triacylglycerol configured such that three molecules of S are bonded.

3. The combined confectionery according to claim 1, wherein the oil-and-fat used for the baked confectionery satisfies the following requirement:
(f): the ratio of mass (USU/SU2) of USU to SU2 being not less than 0.02,
provided that the USU represents the following compound:
USU: a triacylglycerol configured such that U is bonded to the first and third positions and S is bonded to the second position.

4. The combined confectionery according to claim 1, wherein the oil-and-fat used for the baked confectionery comprises 4 to 60 mass % of a transesterified oil-and-fat of a lauric-type oil-and-fat and a non-lauric-type oil-and-fat and 40 to 96 mass % of a low melting point fraction obtained by fractionating a non-lauric-type oil-and-fat.

5. The combined confectionery according to claim 4, wherein
the transesterified oil-and-fat of a lauric-type oil-and-fat and a non-lauric-type oil-and-fat is not less than one transesterified oil-and-fat selected from the group consisting of the following Oil-and-fat A and Oil-and-fat B:
Oil-and-fat A: an oil-and-fat obtained by being transesterified comprising not more than 15 mass % of an unsaturated fatty acid, 20 to 60 mass % of a saturated fatty acid having a carbon number of 12 to 14, 40 to 80 mass % of a saturated fatty acid having a carbon number of 16 to 18 in the whole constituent fatty acid and
Oil-and-fat B: an oil-and-fat obtained by being transesterified comprising 25 to 45 mass % of an unsaturated fatty acid, 15 to 35 mass % of a saturated fatty acid having a carbon number of 12 to 14, 25 to 45 mass % of a saturated fatty acid having a carbon number of 16 to 18 in the whole constituent fatty acid.

6. The combined confectionery according to claim 4, wherein the low melting point fraction obtained by fractonating a non-lauric-type oil-and-fat has an iodine value of not less than 62, and is an oil-and-fat comprising not less than one low melting point fraction selected from the group consisting of a low melting point fraction obtained by fractionating not less than one oil-and-fat selected from the group consisting of a palm-based oil-and-fat and a transesterified oil-and-fat including a palm-based oil-and-fat as a raw material, and a low melting point fraction comprising not less than 50 mass % of StU2,
provided that the St and StU2 represent the following compounds:
St: stearic acid;
StU2: a triacylglycerol configured such that one molecule of St and two molecules of U are bonded.

7. The combined confectionery according to claim 1, wherein the oil-and-fat components of the chocolate satisfy the following requirement (C):
(C): the ratio of mass (SU2/U3) of SU2 to U3 included in the oil-and-fat being not less than 1.

8. The combined confectionery according to claim 1, wherein the oil-and-fat components of the chocolate satisfy the following requirement (D):
(D): a StOSt content being 27 to 65 mass %.

9. The combined confectionery according to claim 1, wherein the oil-and-fat components of the chocolate comprises 60 to 95 mass % of an oil-and-fat rich in SOS, and 5 to 40 mass % of the low melting point fraction obtained by fractionating a non-lauric-type oil-and-fat.

10. The combined confectionery according to claim 9, wherein the oil-and-fat rich in SOS comprises 20 to 100 mass % of a StOSt oil-and-fat.
